(19) United States
(12) Patent Application Publication
(10) Pub. No.: US 2014/0088732 A1
(43) Pub. Date: Mar. 27, 2014

(54) METHODS AND SYSTEMS FOR CONFIGURATION AND MANAGEMENT OF ELECTRONIC CONTROL UNIT

(71) Applicant: SIEMENS PRODUCT LIFECYCLE MANAGEMEN, Plano, TX (US)

(72) Inventors: Ashok Sivaram, Troy, MI (US); Albino Pereira, Moirans (FR); Eric Fang, Shanghai (CN)

(73) Assignee: SIEMENS PRODUCT LIFECYCLE MANAGEMENT SOFTWARE INC., Plano, TX (US)

(21) Appl. No.: 13/628,531

(22) Filed: Sep. 27, 2012

(51) Int. Cl. G05B 11/01

(52) U.S. Cl. CPC G05B 11/01
USPC 700/17

(57) ABSTRACT

Various disclosed embodiments include methods and systems for configuration and management of an electronic control unit (ECU). According to disclosed embodiments, a method for configuration and management of an ECU includes receiving by a data processing system at least one calibration parameter and a corresponding value for the ECU and generating by the data processing system virtual memory locations representing physical memory locations of the ECU. The method includes receiving by the data processing system allocations for the virtual memory locations, wherein the allocations identify blocks and sub-blocks allocated to the calibration parameter and the corresponding value. The method includes generating and storing by the data processing system an output responsive to the allocations, wherein the output contains a memory layout of the stored parameter and the value, and wherein the output is configured to be stored in the physical memory locations of the ECU.

### TECHNICAL FIELD

The present disclosure is directed, in general, to computer-aided design, visualization, and manufacturing systems, product lifecycle management (“PLM”) systems, and similar systems, that manage data for products and other items (collectively, “Product Data Management” systems or PDM systems).

### BACKGROUND OF THE DISCLOSURE

PDM systems manage PLM and other data. Improved systems are desirable.

### SUMMARY OF THE DISCLOSURE

Various disclosed embodiments include methods and systems for configuration and management of an electronic control unit (ECU). According to disclosed embodiments, a method for configuration and management of an ECU includes receiving by a data processing system at least one calibration parameter and a corresponding value for the ECU and generating by the data processing system virtual memory locations representing physical memory locations of the ECU. The method includes receiving by the data processing system allocations for the virtual memory locations, wherein the allocations identify blocks and sub-blocks allocated to the calibration parameter and the corresponding value, wherein the parameter and the corresponding value are stored in the allocated blocks and sub-blocks. The method includes generating and storing by the data processing system an output responsive to the allocations, wherein the output contains a memory layout of the stored parameter and the value, and wherein the output is configured to be stored in the physical memory locations of the ECU.

According to disclosed embodiments, a data processing system for configuration and management of an electronic control unit (ECU) includes at least one processor and a memory connected to the processor. The data processing system is configured to receive at least one calibration parameter and a corresponding value for the ECU and to generate by the processor virtual memory locations representing physical memory locations of the ECU. The data processing system is configured to receive by the processor allocations for the virtual memory locations, wherein the allocations identify blocks and sub-blocks allocated to the calibration parameter and the corresponding value, wherein the parameter and the corresponding value are stored in the allocated blocks and sub-blocks. The data processing system is configured to generate and store by the processor an output responsive to the allocations, wherein the output contains a memory layout of the stored parameter and the value, and wherein the output is configured to be stored in the physical memory locations of the ECU.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system in accordance with disclosed embodiments;

FIG. 2 illustrates calibration of an ECU in accordance with disclosed embodiments;

FIG. 3 illustrates a screenshot of a user interface in accordance with disclosed embodiments;

FIG. 4 illustrates a structure of a virtual memory layout in accordance with disclosed embodiments;

FIG. 5 illustrates a user interface in accordance with disclosed embodiments; and

FIG. 6 is a flowchart of a process according to disclosed embodiments.

### DETAILED DESCRIPTION

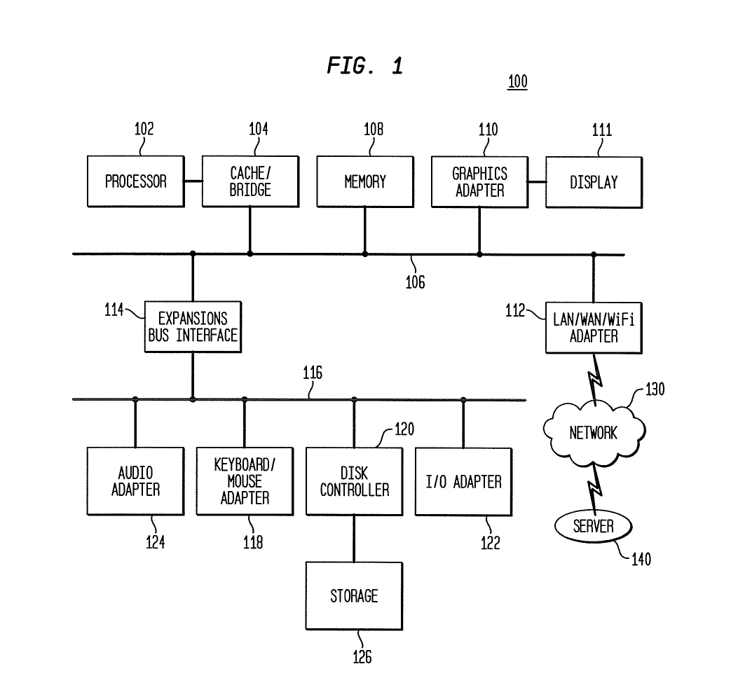

FIGS. 1 through 6, discussed below, and the various embodiments used to describe the principles of the present disclosure in this patent document are by way of illustration only and should not be construed in any way to limit the scope of the disclosure. Those skilled in the art will recognize that the principles of the present disclosure may be implemented in any suitably arranged device or a system. The numerous innovative teachings of the present disclosure will be described with reference to exemplary non-limiting embodiments

Electronic Control Units (ECUs) are used in automotive, aerospace, mobile phones and other applications. An ECU is a microcontroller that may be programmed or calibrated through software or firmware. During calibration, certain parameters (“calibration parameters”) and corresponding values are stored in the ECU memory locations. For example, the ECU may be calibrated with the following:

Calibration Parameter: engine compartment threshold temperature
Value: double/floating point data type 89.56

The ECU may be calibrated with the foregoing calibration parameter and value to trigger an alarm when an engine compartment temperature exceeds 89.56.

Due to changing software versions, parameter versions and value versions, memory locations of calibration parameters and values may change over time. It will be appreciated that a change or update of the software version, a parameter version or a value version may necessitate different spatial requirements which the current memory location may be incapable of accommodating. For example, a parameter may initially be located at location A, but as a result of a change of the parameter (e.g., larger initial value or larger final value), the parameter may require relocation to location B. Consequently, it may be necessary to maintain historical records of memory locations in which multiple versions of the parameters and values were stored.

Currently, manual and error-prone methodologies are used to maintain historical records of multiple versions of calibration parameters and values and their memory locations. For example, spreadsheets are typically used to maintain such historical records. However, use of spreadsheets has drawbacks since it is difficult to maintain traceability.

According to disclosed embodiments, methods and systems manage historical records of memory locations of multiple versions of parameters and values in ECUs. The disclosed embodiments provide a PLM system with a user interface (UI) for allocating blocks and sub-blocks of memory locations in ECUs. According to disclosed embodiments, a PLM system, which manages an application software binary and associated calibration parameters, is advantageously used to allocate memory blocks and sub-blocks for calibration parameters and values for an ECU. Specifically, the UI of the PLM system may be used to allocate memory blocks and to assign start and offset addresses for calibration parameters and values in the memory locations of an ECU.

It will be appreciated that an application software binary is an executable software which runs on a hardware to perform a specific task. A vehicle, for example, may require a control unit for automatic window up/down operation when a button is pressed. An application software binary residing in the control unit may receive a signal instructing a “window down” operation and may initiate the operation.

According to disclosed embodiments, an application software may be configured by setting values of calibration parameters. Information regarding previous calibration parameters used to configure application software and their respective memory locations are maintained. Also, disclosed embodiments provide links to the memory locations of the previously used calibration parameters and application software. Thus, a user is able to trace back to the previously used application software and calibration parameters and their memory locations.

FIG. 1 depicts a block diagram of data processing system 100 in which an embodiment can be implemented, for example as a PDM system particularly configured by software or otherwise to perform the processes as described herein, and in particular as each one of a plurality of interconnected and communicating systems as described herein. The data processing system depicted includes processor 102 connected to level two cache/bridge 104, which is connected in turn to local system bus 106. Local system bus 106 may be, for example, a peripheral component interconnect (PCI) architecture bus. Also connected to local system bus in the depicted example are main memory 108 and graphics adapter 110. Graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

Data processing system 100 in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100. Data processing system 100 may be configured as a workstation, and a plurality of similar workstations may be linked via a communication network to form a distributed system in accordance with embodiments of the disclosure.

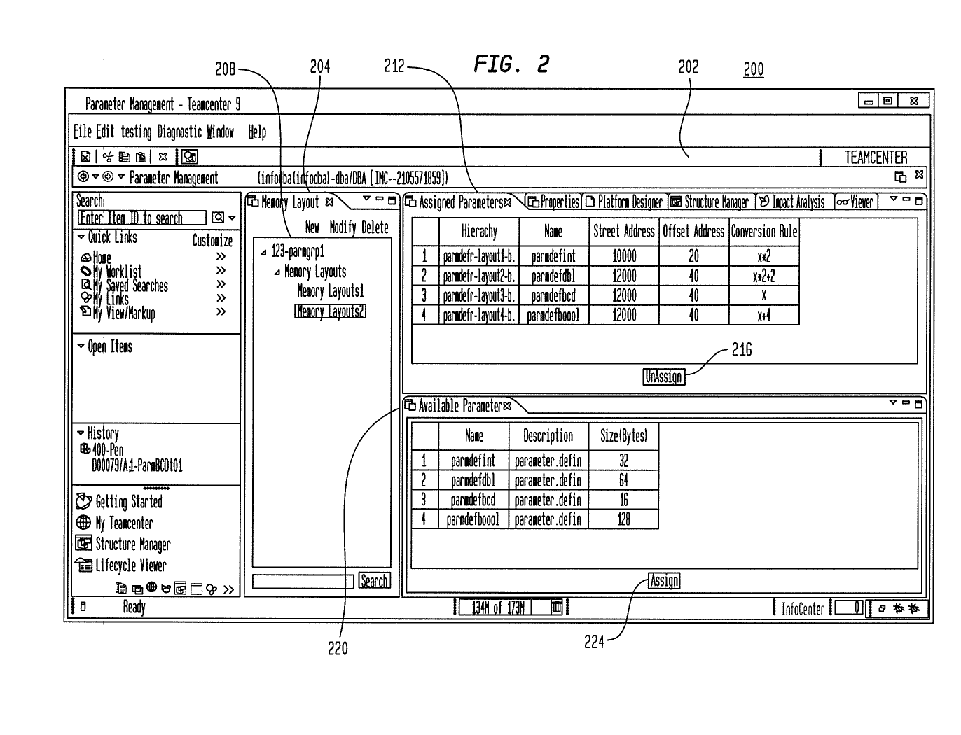

ECUs are typically calibrated to control one or more parts of a product. In the automotive industry, for example, an ECU may be calibrated to control the powertrain section of a vehicle. FIG. 2 illustrates calibration of an ECU via PLM system 200 in accordance with disclosed embodiments. PLM system 200 includes user interface (UI) 202 which provides memory layout 204. An exemplary project 208 entitled “123-parmgrp1” lists assigned parameters under assigned parameters tab 212. The parameters are assigned using assign button 216. A list of available parameters is shown under available parameters 220.

In the above example, a user working on project 208 may be interested in relevant parameters for a powertrain system. The user may identify the relevant parameters from available parameters 220 and assign the relevant parameters using assign button 216. If necessary, the user may remove any assigned parameters using unassign button 224.

According to disclosed embodiments, one or more values of the relevant parameters may be fine-tuned by a feedback control loop to achieve optimum calibration. The optimum values may be entered in PLM system 200 as shown in FIG. 2.

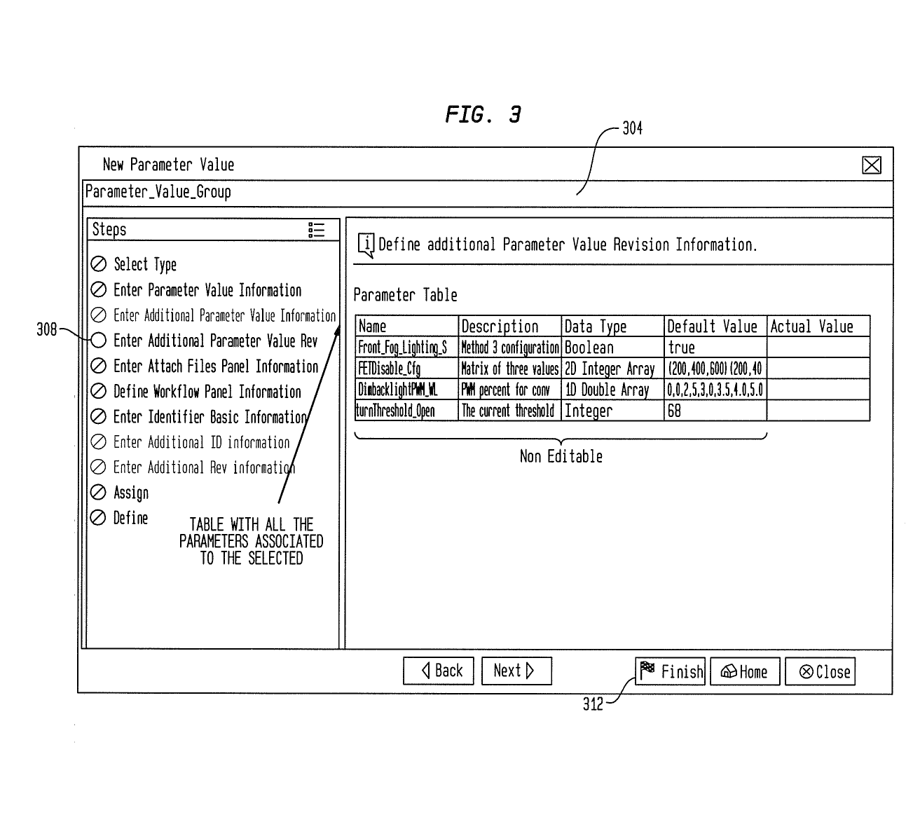

FIG. 3 illustrates a screenshot of the selection of calibration parameters via UI 304 in accordance with disclosed embodiments. UI 304 is invoked after selection of a project as shown in FIG. 2. A user may select one or more parameters and specify values for the selected parameters using parameter value 308. The selected parameters and corresponding values are entered in PLM system 200 using a finish tab 312.

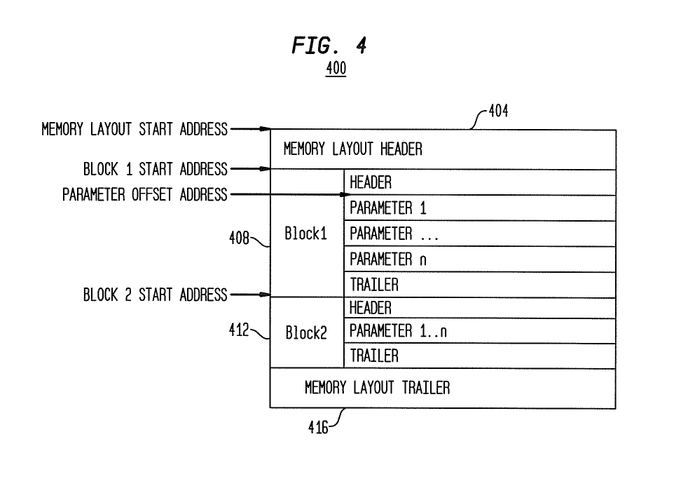

According to disclosed embodiments, after the parameters and corresponding values are entered in PLM system 200, virtual memory locations of an ECU are provided for storing the parameters and values. FIG. 4 illustrates the structure of a virtual memory layout 400 of an ECU according to disclosed embodiments. As shown in FIG. 4, the virtual memory layout includes header 404, blocks 408 and 412, and trailer 416. Each block may have sub-blocks for storing a header, parameters, and a trailer. The blocks and sub-blocks are defined by a start address and an offset address.

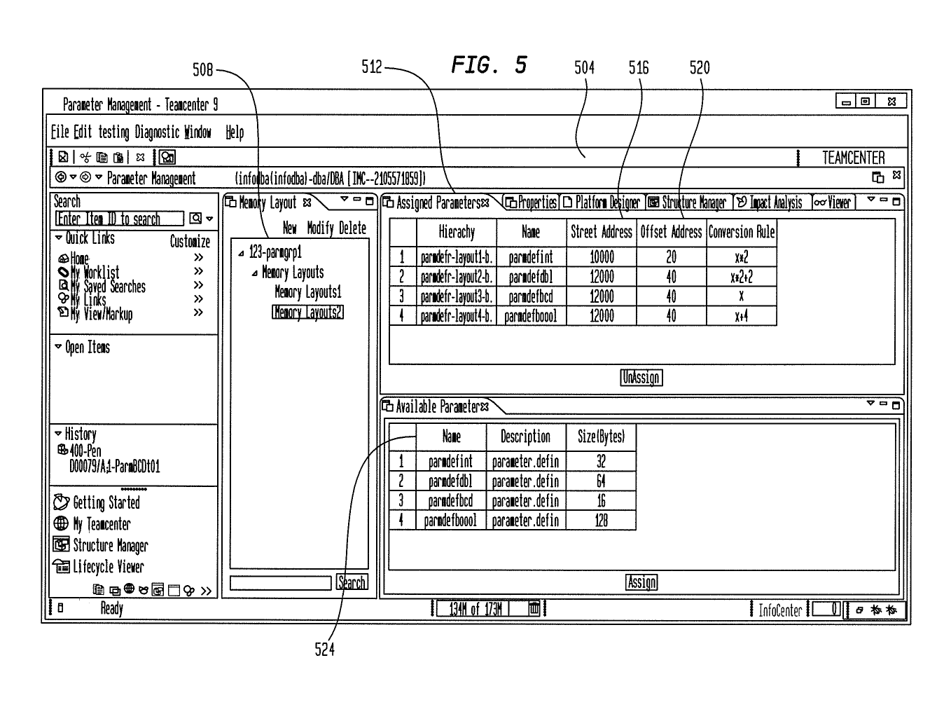

According to disclosed embodiments, PLM system 200 may be used to allocate virtual memory locations, including blocks and sub-blocks, for storing the parameters and corresponding values. PLM system 200 may be used to specify start addresses and offset addresses for the parameters and values. FIG. 5 illustrates UI 504 of PLM system 200 in accordance with disclosed embodiments.

As shown in FIG. 5, project 508 allows allocation on multiple memory layouts: Memory Layout1 and Memory Layout2. UI 504 allows a user to enter parameters 512, start addresses 516 and offset addresses 520. Also, UI 504 lists available parameters 524.

According to disclosed embodiments, a user can link a ROM file generation algorithm to the PLM system. The ROM file may be a binary file that contains the parameters and corresponding values to be stored in memory locations of an ECU. The ROM file includes start addresses and offset addresses for the parameters and the values. According to disclosed embodiments, PLM system 200 allows a user to select a project and a memory layout version, which invokes a file generation algorithm for a ROM file. The ROM file may be uploaded to another application such as, for example, the Teamcenter® product by Siemens Product Lifecycle Management Software, Inc., which establishes traceability. A user interested in examining historical records, including the origin and details, of the ROM file may look at the project and the memory layouts of the ROM file to see what parameters and values were used in multiple versions of the memory layouts.

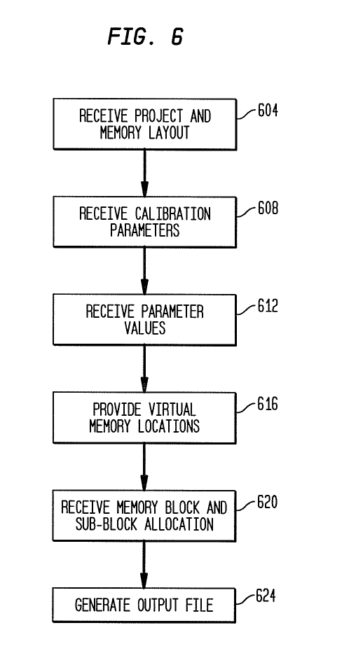

FIG. 6 is a flowchart of a process according to disclosed embodiments. Such a process can be performed, for example, by system 200 as described above, but the “system” in the process below can be any apparatus configured to perform a process as described. In block 604, system 200 receives a selection of a project and a virtual memory layout for the project. As discussed before, a user may select the project and the virtual memory layout via a UI of system 200.

In block 608, system 200 receives a selection of one or more calibration parameters. As discussed before, the UI of system 200 may feature a list of available parameters.

In block 612, system 200 receives values for the selected parameters. As discussed before, the values may be entered via the UI.

In block 616, system 200 provides virtual memory locations for the selected layout. As discussed before, the virtual memory locations correspond to physical memory locations of an ECU.

In block 620, system 200 receives block and sub-block allocations for the virtual memory locations. Specifically, a user via the UI of system 200 allocates the blocks and sub-blocks for the selected calibration parameters and corresponding values. The user identifies the blocks and sub-blocks where the selected parameters and corresponding values will be stored and also specifies the start and offset addresses for the blocks and sub-blocks.

In block 624, system 200 generates an output file responsive to the information entered by a user via the UI. The output file may, for example, be a ROM file which includes the virtual memory layout with the calibration parameters and corresponding values. The output file may be stored in a flash memory drive or other suitable storage device, and the flash memory drive may be used to transfer the data into the memory locations of a physical ECU.

### Create Memory Layout and Artifacts

According to disclosed embodiments, PLM system 200 may be used to create a memory layout for a project. The creation of the memory layout, including block allocations, may be done using, for example, a Rich Application Client (RAC) of the Teamcenter® product, by selecting a Project and then adding blocks and assigning parameters to the blocks using the UI of PLM system 200. Alternately, the creation of a memory layout and assignment of parameters to the blocks can be performed by importing a file such as, for example, an A2L format file.

### Add Memory Blocks to Existing Memory Blocks

According to disclosed embodiments, a user may select existing memory blocks, and using a RAC Software Parameter Manager application, add additional blocks.

### Edit Memory Layout and Blocks

According to disclosed embodiments, a user may select an existing memory layout or a block to perform modification.

### View and Assign Parameters to Blocks

According to disclosed embodiments, a user may select existing an memory layout and blocks in the Software Parameter Manager UI in RAC to find unassigned parameters. The user may select one or more unassigned parameters to assign them to a selected block.

### Remove Assigned Parameters

According to disclosed embodiments, a user may select an existing memory layout and blocks in the Software Parameter Manager UI in RAC to see what parameters have been assigned to a memory layout. The user may select one or more assigned parameters to unassign them.

### Delete Block

According to disclosed embodiments, a user may select existing an memory layout and blocks in the Software Parameter Manager UI in RAC and delete the selected blocks, which also deletes sub-blocks in the deleted blocks. According to disclosed embodiments, the deletion of a block automatically unassigns the parameters in the delected block.

### Copy Block or Memory Layout

According to disclosed embodiments, a user may select an existing memory layout or blocks and copy the layout or the blocks into the Software Parameter Manager UI in RAC.

### Override Address for Parameter Assignments

According to disclosed embodiments, a user may select assigned parameters in the Software Parameter Manager UI for a block or a layout, select an offset address field and enter a different value.

### View Overridden Parameters Used for Specific File Generation

According to disclosed embodiments, a user may select a specific container that contains overridden information used to generate a particular file and view the overrides in a single view.

### Generate and Export File

According to disclosed embodiments, a user may select a memory layout and a Project or dictionary and generate a file. The file may be translated into a specific format which is compatible with a flash drive which may be used to store the file in an ECU.

According to disclosed embodiments, a non-transitory computer-readable medium is encoded with computer-executable instructions for configuration and management of an electronic control unit (ECU). The computer-executable instructions when executed cause at least one data processing system to receive at least one calibration parameter and a corresponding value for the ECU and to generate virtual memory locations representing physical memory locations of the ECU. The computer-executable instructions when executed cause at least one data processing system to receive allocations for the virtual memory locations, wherein the allocations identify blocks and sub-blocks allocated to the calibration parameter and the corresponding value, and wherein the parameter and the corresponding value are stored in the allocated blocks and sub-blocks. The computer-executable instructions when executed cause at least one data processing system to generate and store an output responsive to the allocations, wherein the output contains a memory layout of the stored parameter and the value, and wherein the output is configured to be stored in the physical memory locations of the ECU.

Those skilled in the art will recognize that, for simplicity and clarity, the full structure and operation of all systems suitable for use with the present disclosure is not being depicted or described herein. Instead, only so much of a system as is unique to the present disclosure or necessary for an understanding of the present disclosure is depicted and described. The remainder of the construction and operation of the disclosed systems may conform to any of the various current implementations and practices known in the art.

Of course, those of skill in the art will recognize that, unless specifically indicated or required by the sequence of operations, certain steps in the processes described above may be omitted, performed concurrently or sequentially, or performed in a different order. Further, no component, element, or process should be considered essential to any specific claimed embodiment, and each of the components, elements, or processes can be combined in still other embodiments.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for configuration and management of an electronic control unit (ECU), comprising:
receiving by a data processing system at least one calibration parameter and a corresponding value for the ECU;
generating by the data processing system virtual memory locations representing physical memory locations of the ECU;
receiving by the data processing system allocations for the virtual memory locations, wherein the allocations identify blocks and sub-blocks allocated to the calibration parameter and the corresponding value, wherein the parameter and the corresponding value are stored in the allocated blocks and sub-blocks; and
generating and storing by the data processing system an output responsive to the allocations, wherein the output contains a memory layout of the stored parameter and the value, and wherein the output is configured to be stored in the physical memory locations of the ECU.

2. The method of claim 1, wherein the calibration parameter and the corresponding value are received through a user interface (UI) of the data processing system.

3. The method of claim 1, further comprising receiving by the data processing system an identification of a project associated with the ECU.

4. The method of claim 1, further comprising providing by the UI at least one available calibration parameter.

5. The method of claim 1, further comprising adding new blocks to existing blocks.

6. The method of claim 1, further comprising removing one or more parameters assigned to the blocks and sub-blocks.

7. The method of claim 1, further comprising deleting an allocated block.

8. The method of claim 1, further comprising copying an allocated block.

9. The data processing system for configuration and management of an electronic control unit (ECU), comprising:
at least one processor;
a memory connected to the processor, wherein the data processing system is configured to:
receive at least one calibration parameter and a corresponding value for the ECU;
generate by the processor virtual memory locations representing physical memory locations of the ECU;
receive by the processor allocations for the virtual memory locations, wherein the allocations identify blocks and sub-blocks allocated to the calibration parameter and the corresponding value, wherein the parameter and the corresponding value are stored in the allocated blocks and sub-blocks; and
generate and store by the processor an output responsive to the allocations, wherein the output contains a memory layout of the stored parameter and the value, and wherein the output is configured to be stored in the physical memory locations of the ECU.

10. The data processing system of claim 9, wherein the calibration parameter and the corresponding value are received through a user interface (UI) of the data processing system.

11. The data processing system of claim 9, wherein the UI provides at least one available calibration parameter.

11. The data processing system of claim 9, wherein the UI receives an identification of a project associated with the ECU.

12. The data processing system of claim 9, wherein new blocks are added to existing blocks via the UI.

13. The data processing system of claim 9, wherein one or more parameters assigned to the blocks and sub-blocks are removed via the UI.

14. The data processing system of claim 9, wherein an allocated block is deleted via the UI.

15. The data processing system of claim 1, wherein an allocated block is copied via the UI.

16. A non-transitory computer-readable medium encoded with computer-executable instructions for configuration and management of an electronic control unit (ECU), wherein the computer-executable instructions when executed cause at least one data processing system to:
receive at least one calibration parameter and a corresponding value for the ECU;
generate virtual memory locations representing physical memory locations of the ECU;
receive allocations for the virtual memory locations, wherein the allocations identify blocks and sub-blocks allocated to the calibration parameter and the corresponding value, wherein the parameter and the corresponding value are stored in the allocated blocks and sub-blocks; and
generate and store an output responsive to the allocations, wherein the output contains a memory layout of the stored parameter and the value, and wherein the output is configured to be stored in the physical memory locations of the ECU.

17. The non-transitory computer-readable medium of claim 16, wherein the calibration parameter and the corresponding value are received through a user interface (UI) of the data processing system.

18. The non-transitory computer-readable medium of claim 16, wherein the computer-executable instructions when executed cause at least one data processing system to receive an identification of a project associated with the ECU.

19. The non-transitory computer-readable medium of claim 16, wherein the UI provides at least one available calibration parameter.

20. The non-transitory computer-readable medium of claim 16, wherein the computer-executable instructions when executed cause at least one data processing system to add new blocks to existing blocks.
